(19) United States
(12) Patent Application Publication
(10) Pub. No.: US 2022/0147503 A1
(43) Pub. Date: May 12, 2022

(54) SYSTEMS AND METHODS TO GENERATE A DATABASE STRUCTURE WITH A LOW-LATENCY KEY ARCHITECTURE

(71) Applicant: Massachusetts Mutual Life Insurance Company, Springfield, MA (US)

(72) Inventors: Suresh Babu Punna, Springfield, MA (US); Israel Abraham, Springfield, MA (US); Daniel Jacobsen, Springfield, MA (US)

(73) Assignee: Massachusetts Mutual Life Insurance Company, Springfield, MA (US)

(21) Appl. No.: 17/582,523

(22) Filed: Jan. 24, 2022

Related U.S. Application Data
(63) Continuation-in-part of application No. 17/399,447, filed on Aug. 11, 2021.
(60) Provisional application No. 63/064,148, filed on Aug. 11, 2020.

(51) Int. Cl. G06F 16/22

(52) U.S. Cl. CPC G06F 16/2264; G06F 16/2255

(57) ABSTRACT

Methods and systems described herein are directed at least to a system to generate a database structure with a low-latency key architecture. The system can identify one or more natural keys of at least one dimensional object, the dimensional object corresponding to at least a portion of a database structure, identify at least one dependency of at least one fact object on the dimensional object, the fact object corresponding to the database structure, generate, based on one or more of the natural keys, at least one dimensional identifier associated with the dimensional object, assign, to the dimensional object, the dimensional identifier to the dimensional object, and link, concurrently with the assigning, the fact object to the dimensional object by associating the dimensional identifier with the fact object, to generate the database structure.

### CROSS-REFERENCE TO RELATED PATENT APPLICATIONS

This application is a continuation-in-part of U.S. patent application Ser. No. 17/399,447, filed Aug. 11, 2021, which claims priority to U.S. Provisional Patent Application Ser. No. 63/064,148, entitled “DIMENSIONAL DATA DESIGN USING NATURAL KEYS,” filed Aug. 11, 2020, all of which are incorporated by reference in their entirety.

### TECHNICAL FIELD

The present implementations relate generally to database architecture, and more particularly to generating a database structure with a low-latency key architecture.

### BACKGROUND

Enterprise systems are increasingly operating with minimal downtime, and are increasingly expected to rapidly and responsively communicate information across network and system architectures of all types. However, traditional enterprise systems can experience significant disruption in the event of a system power outage or other operational interruption. These outages or interruptions can cause loss of database builds. Conventional systems can be required to execute time-consuming rebuilds of lost database structures, resulting in longer outages or reduction in responsiveness of enterprise systems with conventional database structures or architectures.

### SUMMARY

Methods and systems described herein are directed at least to a technological solution of a database structure with a low-latency key architecture. The key architecture can enable building and rebuilding of a database structure with aggregate completion times of at least approximately 100 times faster than conventional database structures having a conventional key architecture. The key architectures can be based on natural keys and hashes of the natural keys to provide unique identifiers for multiple tables and types of table at database scale reaching an arbitrarily large size. Present implementations can build or rebuild the database structure in a parallelized manner, and can generate hashes or the like of natural keys based on one or more transformations. Present implementations can also support particular processors or processor types configured or fabricated, for example, to perform optimized parallelized operations with respect to the parallelized operations or the transform operations of present implementations to build or rebuild a database structure. Present implementations can also build or rebuild a portion of the database structure. Thus, a technological solution for generating a database structure with a low-latency key architecture is provided.

In one embodiment, a system to generate a database structure with a low-latency key architecture can include a data processing system including memory and one or more processors to identify one or more natural keys of at least one dimensional object, the dimensional object corresponding to at least a portion of a database structure, identify at least one dependency of at least one fact object on the dimensional object, the fact object corresponding to the database structure, generate, based on one or more of the natural keys, at least one dimensional identifier associated with the dimensional object, assign, to the dimensional object, the dimensional identifier to the dimensional object, and link, concurrently with the assigning, the fact object to the dimensional object by associating the dimensional identifier with the fact object, to generate the database structure.

The system can generate the dimensional identifier by generating a hash of one or more of the natural keys. The dimensional object and the fact object may correspond to respective table structures of the database structure. The system can initiate, in parallel, a build of the database structure to generate the dimensional identifier, assign the dimensional identifier, and link the fact object. The system can initiate, in parallel, a build of the database structure to generate the dimensional identifier and link the fact object in parallel with the assigning. The dimensional identifier can include a universally unique identifier (UUID) derived from one or more of the natural keys. The system can associate the dimensional identifier with the fact object by embedding the dimensional identifier in the fact object. The system may embed the dimensional identifier in a field of the fact object corresponding to a reference to the dimensional object. The system can execute a query operation by referencing the dimensional identifier.

In another embodiment, a method to generate a database structure with a low-latency key architecture can include identifying one or more natural keys of at least one dimensional object, the dimensional object corresponding to at least a portion of a database structure, identifying at least one dependency of at least one fact object on the dimensional object, the fact object corresponding to the database structure, generating, based on one or more of the natural keys, at least one dimensional identifier associated with the dimensional object, assigning, to the dimensional object, the dimensional identifier to the dimensional object, and linking, concurrently with the assigning, the fact object to the dimensional object by associating the dimensional identifier with the fact object, to generate the database structure.

The method can include generating the dimensional identifier by generating a hash of one or more of the natural keys. The dimensional object and the fact object can correspond to respective table structures of the database structure. The method can include initiating, in parallel, a build of the database structure to generate the dimensional identifier, assign the dimensional identifier, and link the fact object. The method can include initiating, in parallel, a build of the database structure to generate the dimensional identifier and link the fact object in parallel with the assigning. The dimensional identifier includes a universally unique identifier (UUID) derived from one or more of the natural keys. Associating the dimensional identifier with the fact object may include embedding the dimensional identifier in the fact object. Embedding may include embedding the dimensional identifier in a field of the fact object corresponding to a reference to the dimensional object. The method can execute a query operation by referencing the dimensional identifier.

In yet another embodiment, a computer readable medium can include one or more instructions stored thereon and executable by a processor to identify, by the first processor, one or more natural keys of at least one dimensional object, the dimensional object corresponding to at least a portion of a database structure, identify, by the first processor, at least one dependency of at least one fact object on the dimensional object, the fact object corresponding to the database structure, generate, by the first processor and based on one or more of the natural keys, at least one dimensional identifier associated with the dimensional object, assign, by the first processor to the dimensional object, the dimensional identifier to the dimensional object, and link, by at least one of the first processor and a second processor, concurrently with the assigning, the fact object to the dimensional object by associating the dimensional identifier with the fact object, to generate the database structure.

The computer readable medium may include one or more instructions executable by the processor to initiate, by the second processor in parallel with the first processor, a build of the database structure to generate the dimensional identifier and link the fact object in parallel with the assigning.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates a system, according to an embodiment.

FIG. 2 illustrates a computer system further to the system of FIG. 1, according to an embodiment.

FIG. 3 illustrates a database structure corresponding to a dimensional table, according to an embodiment.

FIG. 4 illustrates a database structure corresponding to a fact table, according to an embodiment.

FIG. 5 illustrates a database structure including a plurality of tables, according to an embodiment.

FIG. 6 illustrates a method of generating a database structure with a low-latency key architecture, according to an embodiment.

FIG. 7 illustrates a method of generating a database structure with a low-latency key architecture, further to the method of FIG. 6, according to an embodiment.

FIG. 8 illustrates a method of generating a database structure with a low-latency key architecture, further to the method of FIG. 7, according to an embodiment.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

Methods and systems described herein can generate a database structure with multiple advantages over conventional database structures. As one example, the particular technological solution of an improved low-latency database structure and architecture can provide the particular technological improvement of accelerating database build or rebuild operations by at least approximately 100 times, or a 100-fold increase in speed of building or rebuilding a database, as compared to conventional database architectures and structures.

Natural keys can include unique identifiers of a business entity. The natural key can include, for example, respective metadata for any entity. Present implementations can generate a unique HASH UUID as a global natural key. Thus, a key limited in scope to a particular table, subdivision, or namespace, for example, of a database can be eliminated, to reduce and eliminate potential addressing collisions within the database structure.

Present implementations can advantageously improve referential integrity between fact tables and dimension tables by generating links therebetween with a UUID based on a natural key. Thus, the need to rely on surrogate keys with limited scope and higher likelihood of collision within a database namespace, for example, can be advantageously eliminated.

Present implementations can efficiently and effectively parallelize build and rebuild operations associated with a database. These operations can, for example be parallelized by a particular extract, transform and load (ETL) operation optimized to be parallelized. The process can be optimized to be parallelized across multiple nodes or processors, for example. As one example, facts and dimensions can be loaded in parallel to significantly increase database building at a granular level corresponding to database structure components. An integrity check can ensure data integrity at later step. This parallelized architecture can advantageously eliminate lookups on dimensions and dimensional tables. Conventional systems can be less compatible with ETL parallelism, where dimensional tables are generated and addressed before to fact tables to result in a costly lookup operation on dimensions. By advantageously executing build or rebuild operations by a natural key architecture, such costly dimensional table lookups can be avoided, and present implementations can achieve significant performance improvements in database build speed, at least.

In addition, a conformed dimension can operate to perform a reload on only a portion of a database structure. Thus, in the event of an outage affecting a portion of a built database structure in volatile memory, the impacted dimension can be reloaded with a natural key UUID. Thus, by generating a natural key UUID already embedded, for example, in corresponding fact tables, present implementations can significantly reduce or eliminate impact to portions of a database structure where the respective conformed dimension is referenced. Present implementations thus eliminate the constraint imposed on convention systems requiring an entire rebuild including readdressing based on new keys associated with the rebuild, even where source data has not changed.

Present implementations can thus advantageously achieve negligible time of outage of a deployed database, and minimal impact for multiple users in distributed, networked, or like enterprise systems. In addition, fact tables in accordance with present implementations can support both “as of” and “current” queries. The support for both structures can be transparent from a querying or user perspective, enabling improved database integrity independent of additional user intervention or management, or changes in query construction or user behavior. As one example, “as of” can refer to a state of a record at a time a fact record is loaded. As another example, “current” can refer to a state a dimensional record corresponding to a given fact record. Both “as-of” and “current” state queries can utilize a hash developed on natural keys and can join on hash UUID to yield better performance. To support “current” picture, fact tables can include a natural key to facilitate the fetch of “current” pictures of a dimension. As one example, users or applications can pull the “current” of dimension for a given fact.

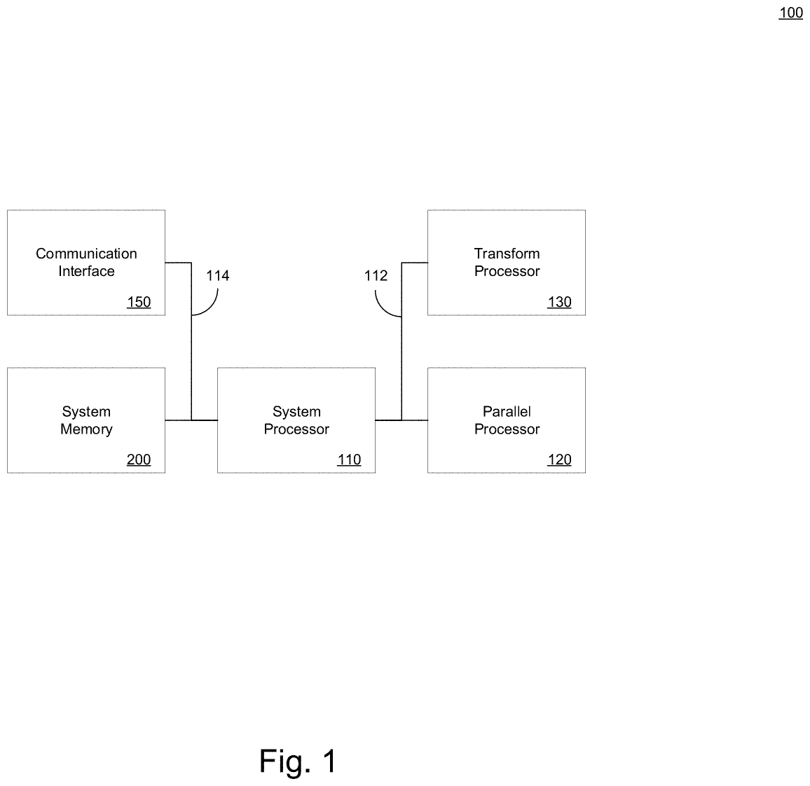

FIG. 1 illustrates a system, according to an embodiment. As illustrated by way of example in FIG. 1, an example processing system 100 includes a system processor 110, a parallel processor 120, a transform processor 130, a system memory 140, and a communication interface 150. At least one of the example processing system 100 or the system processor 110 includes a processor bus 112 and a system bus 114.

The system processor 110 can execute one or more instructions. The instructions can be associated with at least one of the system memory 140 or the communication interface 150. The system processor 110 can include an electronic processor, an integrated circuit, or the like including one or more of digital logic, analog logic, digital sensors, analog sensors, communication buses, volatile memory, nonvolatile memory, and the like. The system processor 110 can include but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. The one or more instructions can include at least one of firmware, software, hardware, operating systems, embedded operating systems, or the like.

The processor bus 112 can communicate one or more instructions, signals, conditions, states, or the like between one or more of the system processor 110, the parallel processor 120, and the transform processor 130. The processor bus 112 can include one or more digital, analog, or like communication channels, lines, traces, or the like. It is to be understood that any electrical, electronic, or like devices, or components associated with the system bus 114 can also be associated with, integrated with, integrable with, supplemented by, complemented by, or the like, the system processor 110 or any component thereof.

The system bus 114 can communicate one or more instructions, signals, conditions, states, or the like between one or more of the system processor 110, the system memory 140, and the communication interface 150. The system bus 114 can include one or more digital, analog, or like communication channels, lines, traces, or the like. It is to be understood that any electrical, electronic, or like devices, or components associated with the system bus 114 can also be associated with, integrated with, integrable with, supplemented by, complemented by, or the like, the system processor 110 or any component thereof.

The parallel processor 120 can execute one or more instructions concurrently, simultaneously, or the like. The parallel processor 120 can execute one or more instructions in a parallelized order in accordance with one or more parallelized instruction parameters. Parallelized instruction parameters can include one or more sets, groups, ranges, types, or the like, associated with various instructions. The parallel processor 120 can include one or more execution cores variously associated with various instructions. The parallel processor 120 can include one or more execution cores variously associated with various instruction types or the like. The parallel processor 120 can include an electronic processor, an integrated circuit, or the like including one or more of digital logic, analog logic, communication buses, volatile memory, nonvolatile memory, and the like. The parallel processor 120 can include but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It is to be understood that any electrical, electronic, or like devices, or components associated with the parallel processor 120 can also be associated with, integrated with, integrable with, supplemented by, complemented by, or the like, the system processor 110 or any component thereof.

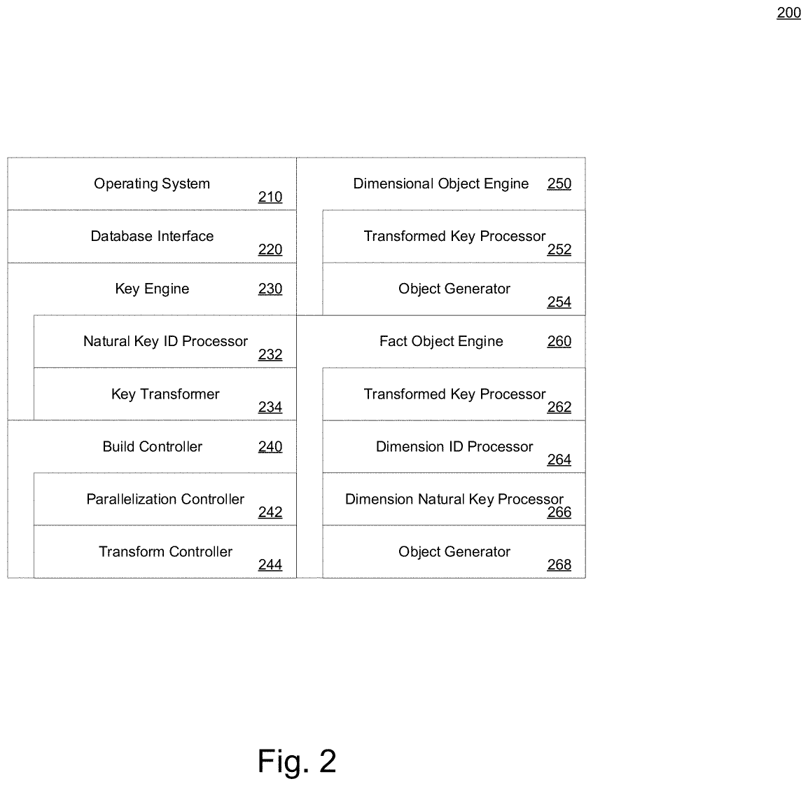

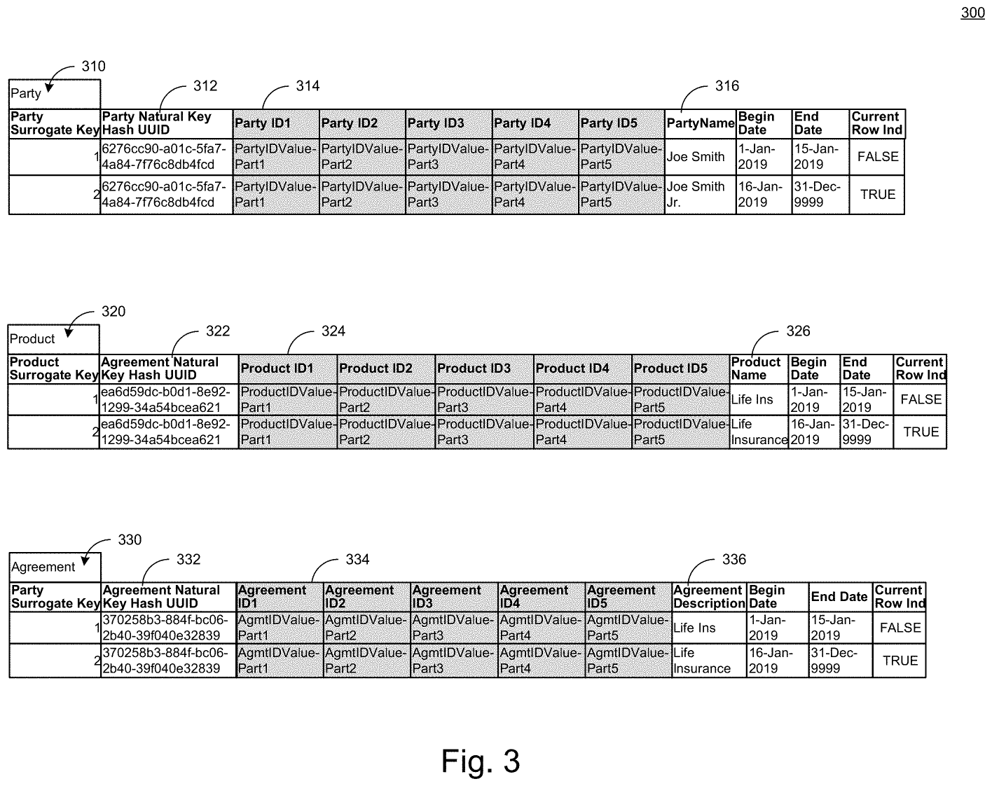

Various cores of the parallel processor 120 can be associated with one or more parallelizable operations in accordance with one or more metrics, engines, models, and the like, of the example computing system of FIG. 3. As one example, parallelizable operations include processing portions of an image, video, waveform, audio waveform, processor thread, one or more layers of a learning model, one or more metrics of a learning model, one or more models of a learning system, and the like. A predetermined number or predetermined set of one or more particular cores of the parallel processor 120 can be associated exclusively with one or more distinct sets of corresponding metrics, engines, models, and the like, of the example computing system of FIG. 2. As one example, a first core of the parallel processor 120 can be assigned to, associated with, configured to, fabricated to, or the like, execute one engine of the computing system of FIG. 2. In this example, a second core of the parallel processor 120 can also be assigned to, associated with, configured to, fabricated to, or the like, execute another engine of the computing system of FIG. 2. Thus, the parallel processor 120 can parallelize execution across one or more metrics, engines, models, and the like, of the computing system of FIG. 2. Similarly, a predetermined number or predetermined set of one or more particular cores of the parallel processor 120 can be associated collectively with corresponding metrics, engines, models, and the like, of the computing system of FIG. 2. As one example, a first plurality of cores of the parallel processor can be assigned to, associated with, configured to, fabricated to, or the like, execute one engine of the computing system of FIG. 2. In this example, a second plurality of cores of the parallel processor can also be assigned to, associated with, configured to, fabricated to, or the like, execute another engine of the computing system of FIG. 2. Thus, the parallel processor 120 can parallelize execution within one or more metrics, engines, models, and the like, of the computing system of FIG. 2.

The transform processor 130 can execute one or more instructions associated with one or more predetermined transformation processes. As one example, transformation processes include Fourier transforms, matrix operations, calculus operations, combinatoric operations, trigonometric operations, geometric operations, encoding operations, decoding operations, compression operations, decompression operations, image processing operations, audio processing operations, and the like. The transform processor 130 can execute one or more transformation processes in accordance with one or more transformation instruction parameters. Transformation instruction parameters can include one or more instructions associating the transform processor 130 with one or more predetermined transformation processes. The transform processor 130 can include one or more transformation processes. The transform processor 130 can include a plurality of transform processors 130 variously associated with various predetermined transformation processes. The transform processor 130 can include a plurality of transformation processing cores each associated with, configured to execute, fabricated to execute, or the like, a predetermined transformation process. The transform processor 130 can include an electronic processor, an integrated circuit, or the like including one or more of digital logic, analog logic, communication buses, volatile memory, nonvolatile memory, and the like. The transform processor 130 can include but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It is to be understood that any electrical, electronic, or like devices, or components associated with the transform processor 130 can also be associated with, integrated with, integrable with, supplemented by, complemented by, or the like, the system processor 110 or any component thereof.

The transform processor 130 can be associated with one or more predetermined transform processes in accordance with one or more metrics, engines, models, and the like, of the computing system of FIG. 2. A predetermined transform process of the transform processor 130 can be associated with one or more corresponding metrics, engines, models, and the like, of the computing system of FIG. 2. As one example, the transform processor 130 can be assigned to, associated with, configured to, fabricated to, or the like, execute one matrix operation associated with one or more engines, metrics, models, or the like, of the computing system of FIG. 2. As another example, the transform processor 130 can alternatively be assigned to, associated with, configured to, fabricated to, or the like, execute another matrix operation associated with one or more engines, metrics, models, or the like, of the example computing system of FIG. 2. Thus, the transform processor 130 can centralize, optimize, coordinate, or the like, execution of a transform process across one or more metrics, engines, models, and the like, of the example computing system of FIG. 2. The transform processor may be fabricated to, configured to, or the like, execute a particular transform process with at least one of a minimum physical logic footprint, logic complexity, heat expenditure, heat generation, power consumption, or the like, with respect to one or more metrics, engines, models, and the like, of the example computing system of FIG. 2.

The system memory 140 can store data associated with the example processing system 100. The system memory 140 can include one or more hardware memory devices for storing binary data, digital data, or the like. The system memory 140 include one or more electrical components, electronic components, programmable electronic components, reprogrammable electronic components, integrated circuits, semiconductor devices, flip flops, arithmetic units, or the like. The system memory 140 can include at least one of a non-volatile memory device, a solid-state memory device, a flash memory device, or a NAND memory device. The system memory 140 can include one or more addressable memory regions disposed on one or more physical memory arrays. As one example, a physical memory array can include a NAND gate array disposed on a particular semiconductor device, integrated circuit device, or printed circuit board device.

The communication interface 150 can communicatively couple the system processor 110 to an external device. An external device includes but is not limited to a smartphone, mobile device, wearable mobile device, tablet computer, desktop computer, laptop computer, cloud server, local server, and the like. The communication interface 150 can communicate one or more instructions, signals, conditions, states, or the like between one or more of the system processor 110 and the external device. The communication interface 150 includes one or more digital, analog, or like communication channels, lines, traces, or the like. As one example, the communication interface 150 can include at least one serial or parallel communication line among multiple communication lines of a communication interface. The communication interface 150 can include one or more wireless communication devices, systems, protocols, interfaces, or the like. The communication interface 150 can include one or more logical or electronic devices including but not limited to integrated circuits, logic gates, flip flops, gate arrays, programmable gate arrays, and the like. The communication interface 150 can include one or more telecommunication devices including but not limited to antennas, transceivers, packetizers, wired interface ports, and the like. It is to be understood that any electrical, electronic, or like devices, or components associated with the communication interface 150 can also be associated with, integrated with, integrable with, replaced by, supplemented by, complemented by, or the like, the system processor 110 or any component thereof.

FIG. 2 illustrates a computer system further to the system of FIG. 1. As illustrated by way of example in FIG. 2, an example computer system 200 can include an operating system 210, a database interface 220, a key engine 230, a build controller 240, a dimensional engine 250, and a fact object engine 260.

The operating system 210 can include hardware control instructions and program execution instructions. The operating system 210 can include a high level operating system, a server operating system, an embedded operating system, or a boot loader. The operating system 210 can include one or more instructions operable specifically with or only with one or more of the system processor 110, the parallel processor 120, and the transform processor 130.

The database interface 220 can communicatively couple the operating system 210 to a database structure. A database structure can include, but is not limited to, one or more database objects, records, or the like, or any reference or link thereto, or the like. The database interface 220 can communicate one or more instructions, signals, conditions, states, or the like between one or more of the operating system 210 and components, devices, blocks operatively coupled or couplable therewith. The database interface 220 can include one or more digital, analog, or like communication channels, lines, traces, or the like. As one example, the database interface 220 can include at least one serial or parallel communication line among multiple communication lines of a communication interface. The database interface 220 can include one or more wireless communication devices, systems, protocols, interfaces, or the like. The database interface 220 can include one or more logical or electronic devices including but not limited to integrated circuits, logic gates, flip flops, gate arrays, programmable gate arrays, and the like. The database interface 220 can be associated with one or more telecommunication devices including but not limited to packetizers, and wired interface ports.

The key engine 230 can include one or more instructions to generate one or more keys associated with a particular database structure, object, or the like. The key engine can generate unique keys for each table of a particular database. The key engine 230 can generate a unique key that is replicable across multiple builds and remains consistent across multiple builds. Thus, the key engine 230 can generate keys that are advantageously both unique and consistent across an arbitrarily large number of database tables, to eliminate the need to regenerate all keys upon database build or rebuild to ensure no key collisions occur. The key engine 230 can include a natural key ID processor 232 and a key transformer 234.

The natural key ID processor 232 can identify one or more tables of a database structure for lading into an operating state, and can identify one or more natural keys associated with each table. An operating state can include loading of one or more portions of a database into volatile memory of the system or a system in communication with the system by the database interface 220. The natural key ID processor 232 can identify, or additionally, generate, one or more natural keys associated with one or more particular tables or portions of a database structure. Thus, the natural key ID processor 232 can identify particular natural keys unique to particular database tables, for database structures having an arbitrary number of tables. The key transformer 234 can include one or more transformation processes for generating a transformed key based on a natural key of a particular table. The transformed key can be unique globally against all other keys of the particular database structure, or against all database structures in an enterprise environment. The key transformer 234 can include one or more predetermined transformation models. As one example, a transformation model can include a particular hashing process. The transform processor 130 can be optimized to execute the particular transformation model associated with the key transformer 234.

The build controller 240 can include one or more instructions to control a database build or rebuild operation associated with a particular database structure. The build controller 240 can optimize build or rebuild of a database structure in accordance with one or more parallelization protocols or one or more transform operations, or any combination thereof. As one example, the build controller 240 can manage ETL through parallelization of particular steps or portions of a build or rebuild. The build controller 240 can include a parallelization controller 242 and a transform controller 244. The parallelization controller 242 can control and execute one or more parallelized operations with respect to a database build or rebuild. The parallelization controller 242 can include one or more instructions optimized for execution by the parallel processor 120, and can coordinate parallelization of a database build or rebuild across one or more parallel processors. The transform controller 244 can include one or more instructions optimized for execution by the transform processor 130, and can coordinate execution of particular transform operations within a database build or rebuild, across one or more transform processors.

The dimensional engine 250 can include one or more instructions to generate one or more dimensional objects associated with one or more transformed keys. The dimensional engine 250 can build or rebuild one or more dimensional tables based on a database record corresponding to the dimensional table. The dimensional engine 250 can interface with a database record by the database interface 220, and can obtain an arbitrary number of dimensional tables from a database record. The dimensional engine 250 can load one or more database records into a volatile memory, by creating a database object based on a database table. As one example, the database object can be a dimensional table, and the database record can be a database table corresponding to the particular dimensional table. The dimensional engine 250 can include a transformed key processor 252 and an object generator 254. The transformed key processor 252 can obtain a transformed key generated or obtained by the key transformer 234. The transformed key processor 252 can associate a transformed key with a particular dimensional table. As one example, the transformed key processor 252 can assign a transformed key to a dimensional table as an identifier of the dimensional table. As another example, the transformed key processor 252 can embed a transformed key into a field of a dimensional table as an identifier of the dimensional table or as a reference to another database table or object. The object generator 254 can generate a particular dimensional table based on a particular database record corresponding to the dimensional table. As one example, the object generator 254 can obtain a database record from a database by the database interface 220, and can load a dimensional object into local memory or a remote memory, derived from the obtained database record. The object generator 254 can load the dimensional object into a remote memory by the database interface 220.

The fact object engine 260 can include one or more instructions to generate one or more fact objects associated with one or more transformed keys. The fact object engine 260 can build or rebuild one or more fact tables based on a database record corresponding to the fact table. The fact object engine 260 can interface with a database record by the database interface 220, and can obtain an arbitrary number of fact tables from a database record. The fact object engine 260 can load one or more database records into a volatile memory, by creating a database object based on a database table. As one example, the database object can be a fact table, and the database record can be a fact table corresponding to the particular fact table. The fact object engine 260 can include a transformed key processor 262, a dimension ID processor 264, a dimension natural key processor 266, and an object generator 268. The transformed key processor 262 can associate a transformed key with a particular fact table. As one example, the transformed key processor 262 can assign a transformed key to a fact table as an identifier of the fact table. As another example, the transformed key processor fact 252 can embed a transformed key into a field of a fact table as an identifier of the fact table or as a reference to another database table or object.

The dimension ID processor 264 can include one or more instructions to identify one or more dimensional tables associated with a particular fact table. The dimension ID processor 264 can identify one or more dimensional tables, database records corresponding to dimensional tables, or dimensional objects. The dimension ID processor 264 can identify one or more fact tables into which to embed one or more transformed keys corresponding to a dimensional table referenced by the fact table. Thus, the dimension ID processor 264 can identify the correct transformed keys to embed into a particular fact table to generate a link between a fact object and a dimensional object that matches a database structure or a database record.

The dimension natural key processor 266 can include one or more instructions to associate, embed, or link, for example, one or more transformed keys with or into one or more dimensional objects or fact objects. As one example, the dimension natural key processor 266 can obtain one or more transformed keys corresponding to identifiers of one or more corresponding dimensional objects or tables, and can embed those transformed keys into one or more fields of a fact table associated with the particular dimensional table. Thus, the dimension natural key processor 266 can generate links between particular fact objects and particular dimensional objects through a particular transformed key. The transformed key can be embedded in the fact object and can correspond to hash UUID of a particular fact table, for example. The dimension natural key processor 266 can advantageously perform one or more operations to embed or link a fact object with a dimensional object, before the dimensional object has been loaded or generated. This ability to link a fact object with a dimensional object before the dimensional object is generated is one example of a technological improvement of a database structure and database build process, and results in technological advantages including, but not limited to, significantly reduced downtime of a database deployment and significantly increased build or rebuild speed for a particular database deployment. As one example, the dimension natural key processor 266 can generate transformed keys based on one or more natural keys of a particular dimensional table or object. The dimension natural key processor 266 can perform parallelized operations, for example, with instructions optimized for parallel execution by the parallel processor 120, to even further increase speed of build or rebuild.

The object generator 268 can generate a particular fact table based on a particular database record corresponding to the fact table. As one example, the object generator 268 can obtain a database record from a database by the database interface 220, and can load a fact object into local memory or a remote memory, derived from the obtained database record. The object generator 268 can load the fact object into a remote memory by the database interface 220.

FIG. 3 illustrates a database structure corresponding to a dimensional table, according to an embodiment. As illustrated by way of example in FIG. 3, an example structure 300 can include a first dimensional table 310, a second dimensional table 320, and a third dimensional table 330.

The first dimensional table 310 can include a transformed key portion 312, an identifiers portion 314, and a content portion 316. The transformed key portion 312 can include one or more transformed keys associated with a particular record of the first dimensional table 310. The record can correspond, for example, to a row of the first dimensional table 310. The identifiers portion 314 can correspond to one or more identifiers for a particular record distinct from the transformed key associated with the record. The content portion 316 can include one or more fields with content information associated with the record. The content fields can include, for example, values or other information for one or more characteristics of the data record. As one example, the first dimensional table 310 can include records of particular parties or entities, with each row corresponding to a distinct party or entity.

The second dimensional table 320 can include a transformed key portion 322, an identifiers portion 324, and a content portion 326. The transformed key portion 322 can include one or more transformed keys associated with a particular record of the second dimensional table 320. The record can correspond, for example, to a row of the second dimensional table 320. The identifiers portion 324 can correspond to one or more identifiers for a particular record distinct from the transformed key associated with the record. The content portion 326 can include one or more fields with content information associated with the record. The content fields can include, for example, values or other information for one or more characteristics of the data record. As one example, the second dimensional table 320 can include records of particular products, with each row corresponding to a distinct product.

The third dimensional table 330 can include a transformed key portion 332, an identifiers portion 334, and a content portion 336. The transformed key portion 332 can include one or more transformed keys associated with a particular record of the third dimensional table 330. The record can correspond, for example, to a row of the third dimensional table 330. The identifiers portion 334 can correspond to one or more identifiers for a particular record distinct from the transformed key associated with the record. The content portion 336 can include one or more fields with content information associated with the record. The content fields can include, for example, values or other information for one or more characteristics of the data record. As one example, the third dimensional table 330 can include records of particular agreements, with each row corresponding to a distinct agreement.

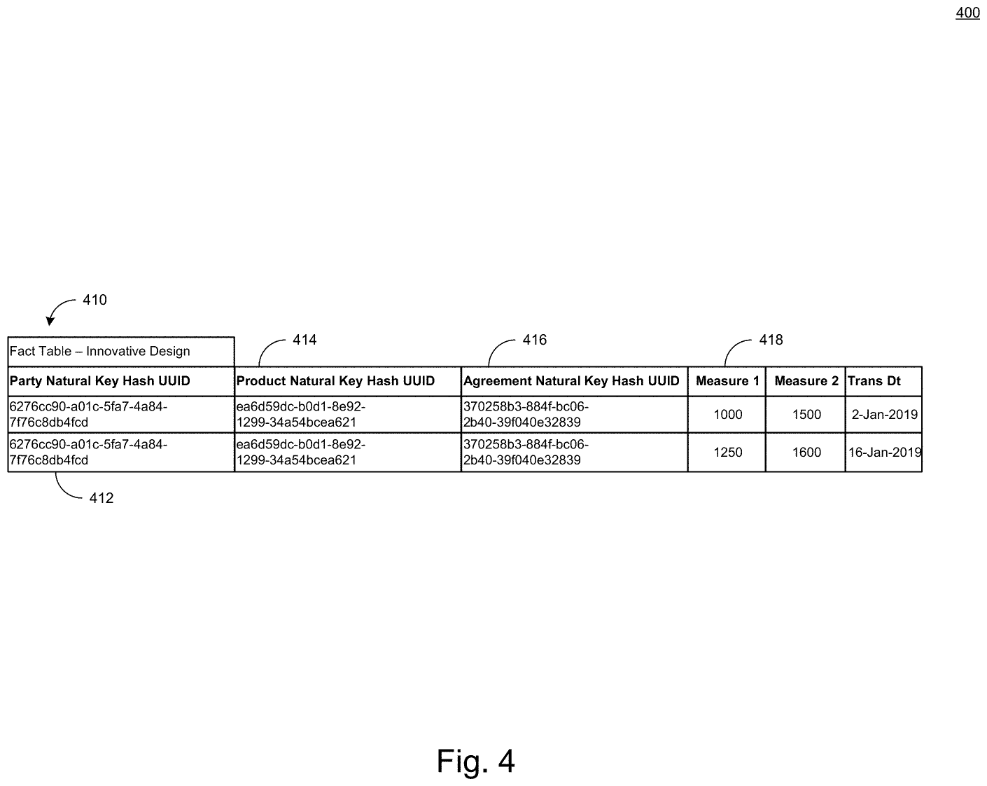

FIG. 4 illustrates a database structure corresponding to a fact table, according to an embodiment. As illustrated by way of example in FIG. 4, an example structure 400 can include a fact table 140.

The fact table 410 can include a first key portion 412, a second key portion 414, a third key portion 416, and a content portion 418. The first key portion 412 can include a first key corresponding to a particular dimensional record of a first dimensional object. As one example, the first key portion 412 can correspond to a party or entity dimensional object, and can include a first transformed key linking a particular record of the fact object with a particular corresponding record of a dimensional object. The second key portion 414 can include a second key corresponding to a particular dimensional record of a second dimensional object. As one example, the second key portion 414 can correspond to a product dimensional object, and can include a second transformed key linking a particular record of the fact object with a particular corresponding record of a dimensional object. The third key portion 416 can include a third key corresponding to a particular dimensional record of a third dimensional object. As one example, the third key portion 416 can correspond to an agreement dimensional object, and can include a third transformed key linking a particular record of the fact object with a particular corresponding record of a dimensional object.

The content portion 418 can include one or more fields with content information associated with a particular record of the fact table. The content fields can include, for example, values or other information for one or more characteristics of the data record. As one example, the fact table 410 can include records referencing one or more of particular parties or entities, particular products, and particular agreements, with each row corresponding to a distinct entry.

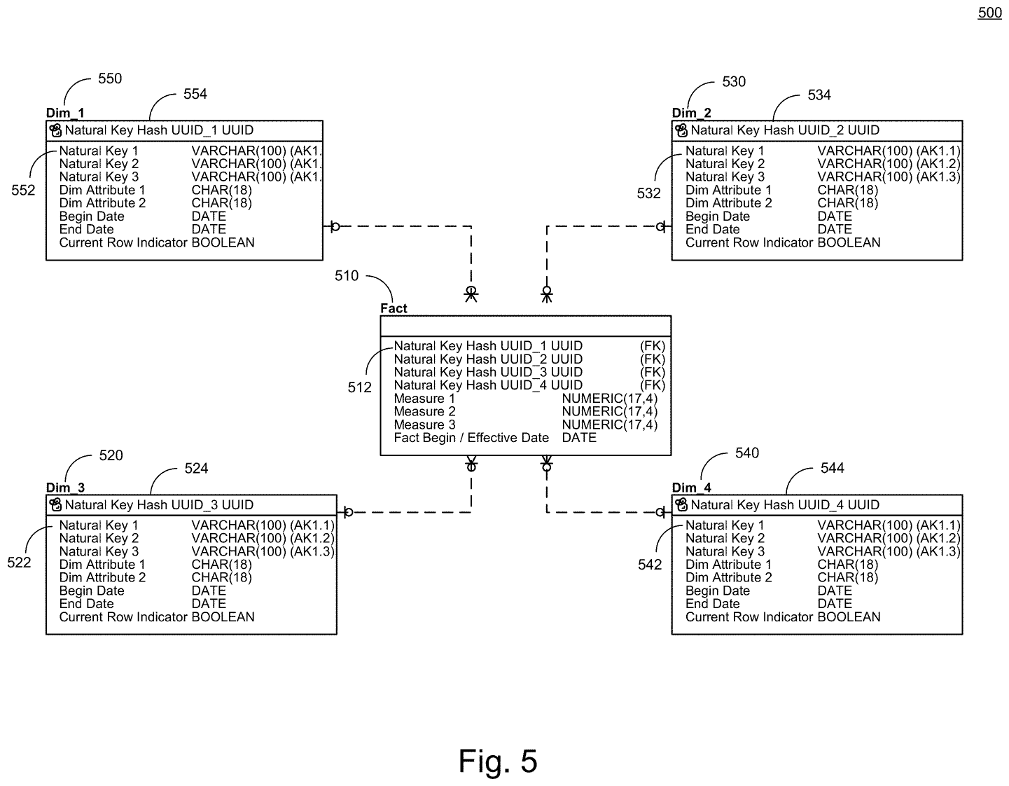

FIG. 5 illustrates a database structure including a plurality of tables, according to an embodiment. As illustrated by way of example in FIG. 5, an example structure 500 can include a fact object 510 and dimensional objects 520, 530, 540 and 550. It is to be understood that present implementations are not limited to the number or arrangement of fact objects and dimensional objects discussed herein.

The fact object 510 can correspond at least partially in one or more of structure and operation to the fact table 410. The fact object 510 can include a plurality of transformed keys 512 each linking the fact object 510 to corresponding ones of the dimensional objects 520, 530, 540 and 550. Each of the dimensional objects 520, 530, 540 and 550 can include corresponding transformed keys as identifiers 524, 534, 544 and 554 of the dimensional objects 520, 530, 540 and 550. Each of the dimensional objects 520, 530, 540 and 550 can also include various natural keys 522, 532, 542 and 552. The identifiers 524, 534, 544 and 554 can be, for example, derived at least partially from the various natural keys 522, 532, 542 and 552 of their corresponding dimensional tables.

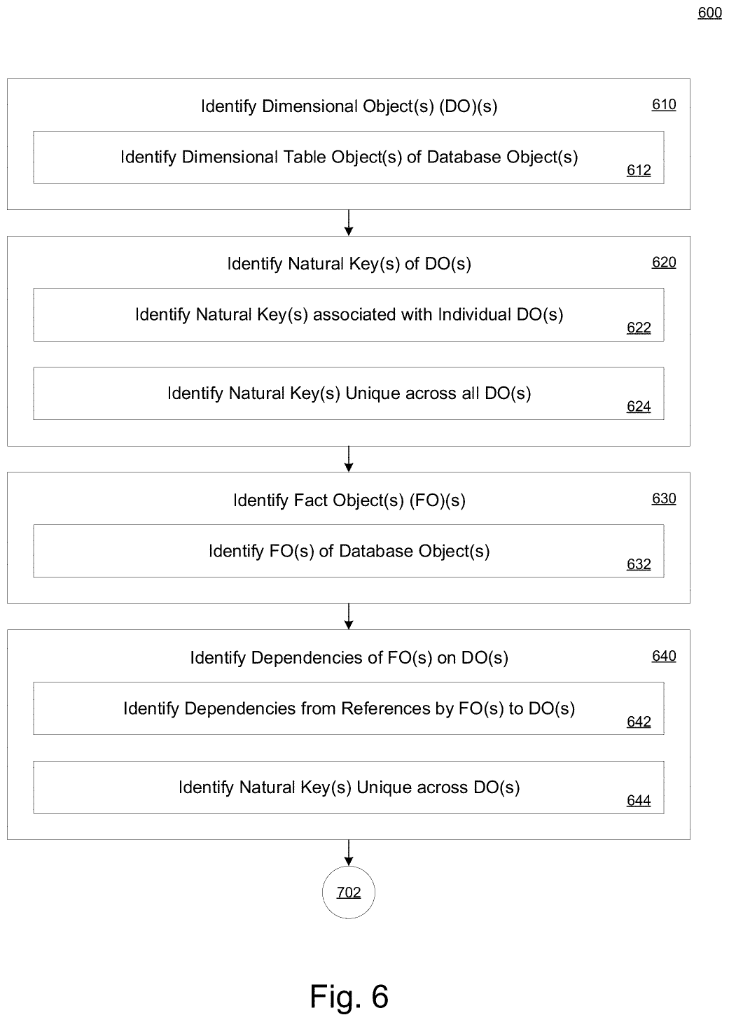

FIG. 6 illustrates a method of generating a database structure with a low-latency key architecture, according to an embodiment. At least one of the example systems 100 and 200 can perform method 600, according to an embodiment. The method 600 can begin at step 610.

At step 610, the method can identify one or more dimensional objects. Step 610 can include step 612. At step 612, the method can identify one or more dimensional table objects corresponding to one or more dimensional objects. The method 600 can then continue to step 620.

At step 620, the method can identify one or more natural keys corresponding to one or more dimensional objects. Step 620 can include at least one of steps 622 and 624. At step 622, the method can identify one or more natural keys associated with individual dimensional objects. At step 624, the method can identify one or more natural keys unique across all dimensional objects. The method 600 can then continue to step 630.

At step 630, the method can identify one or more fact objects. Step 630 can include step 632. At step 632, the method can identify one or more fact objects corresponding to one or more dimensional objects. The method 600 can then continue to step 640.

At step 640, the method can identify one or more dependencies of one or more fact objects on one or more dimensional objects. Step 640 can include at least one of steps 642 and 644. At step 642, the method can identify one or more dependencies based at least partially on references from one or more particular facto objects to one or more particular dimensional objects. At step 644, the method can identify one or more natural keys unique across all dimensional objects. The method 600 can then continue to step 702.

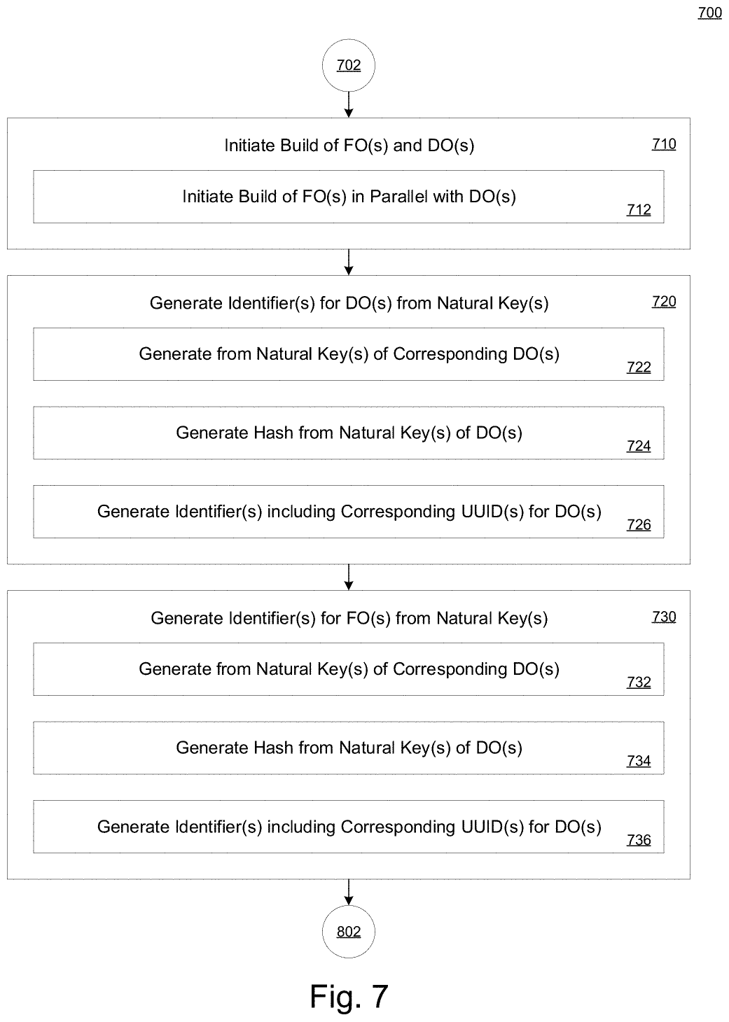

FIG. 7 illustrates a method of generating a database structure with a low-latency key architecture, further to the method of FIG. 6. At least one of the example systems 100 and 200 can perform method 700 according to present implementations. The method 700 can begin at step 702. The method 700 can then continue to step 710.

At step 710, the method can initiate a build of one or more fact objects and one or more dimensional objects. Step 710 can include step 712. At step 712, the method can initiate a build of one or more fact objects in parallel with one or more dimensional objects. The method 700 can then continue to step 720.

At step 720, the method can generate one or more identifiers for one or more dimensional objects, based at least partially on one or more natural keys. Step 720 can include at least one of steps 722, 724 and 726. At step 722, the method can generate one or more identifiers from a natural key corresponding to a particular dimensional object. At step 724, the method can generate a hash from or based on a natural key associated with a dimensional object. At step 726, the method can generate one or more identifiers including at least one corresponding UUID for a corresponding dimensional object. The method 700 can then continue to step 730.

At step 730, the method can generate one or more identifiers for one or more fact objects, based at least partially on one or more natural keys. Step 730 can include at least one of steps 732, 734 and 736. At step 732, the method can generate one or more identifiers from a natural key corresponding to a particular dimensional object. At step 734, the method can generate a hash from or based on a natural key associated with a dimensional object. At step 736, the method can the method can generate one or more identifiers including at least one corresponding UUID for a corresponding dimensional object. The method 700 can then continue to step 802.

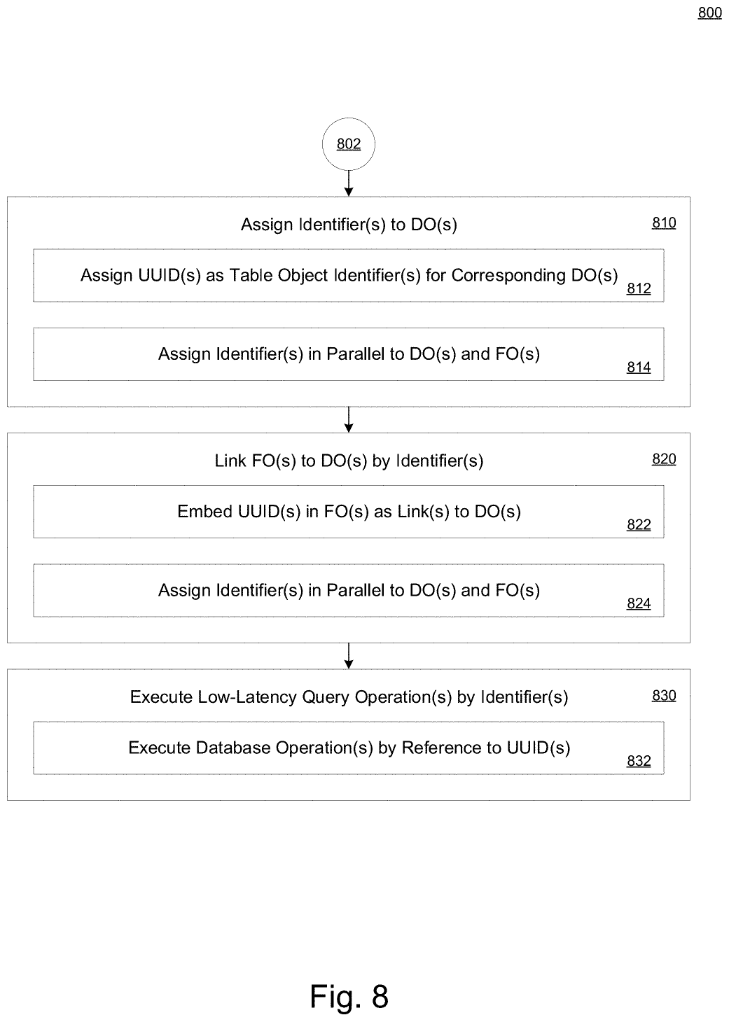

FIG. 8 illustrates a method of generating a database structure with a low-latency key architecture, further to the method of FIG. 7. At least one of the example systems 100 and 200 can perform method 800, according to an embodiment. The method 800 can begin at step 802. The method 800 can then continue to step 810.

At step 810, the method can assign one or more identifiers to one or more dimensional objects. Step 810 can include at least one of steps 812 and 814. At step 812, the method can assign one or more UUIDs as table object identifiers for corresponding dimensional objects. At step 814, the method can assign one or more identifiers in parallel to one or more dimensional objects and one or more fact objects. The method 800 can then continue to step 820.

At step 820, the method can link one or more fact objects to one or more dimensional objects by one or more corresponding identifiers. Step 820 can include at least one of steps 822 and 824. At step 822, the method can embed one or more UUIDs in at least one fact object as links to one or more corresponding and particular dimensional objects. At step 824, the method can assign one or more identifiers in parallel to one or more dimensional objects and one or more fact objects. The method 800 can then continue to step 830.

At step 830, the method can execute at least one low-latency query operation based on one or more of the identifiers. The method can execute a low-latency query operation by traversing the links corresponding to the identifiers. The method can execute a low-latency query operation by incorporating a high-speed parallelized build operation into a query operation request, in the event that a rebuild of a database structure is discovered in response to initiating a particular query. Step 830 can include step 832. At step 832, the method can execute one or more database operations by reference to one or more UUIDs. The method 800 can end at step 830.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A system to generate a database structure with a low-latency key architecture, the system comprising:
a data processing system comprising memory and one or more processors to:
identify one or more natural keys of at least one dimensional object, the dimensional object corresponding to at least a portion of a database structure;
identify at least one dependency of at least one fact object on the dimensional object, the fact object corresponding to the database structure;
generate, based on one or more of the natural keys, at least one dimensional identifier associated with the dimensional object;
assign, to the dimensional object, the dimensional identifier to the dimensional object; and
link, concurrently with the assigning, the fact object to the dimensional object by associating the dimensional identifier with the fact object, to generate the database structure.

2. The system of claim 1, the system further to:
generate the dimensional identifier by generating a hash of one or more of the natural keys.

3. The system of claim 1, wherein the dimensional object and the fact object correspond to respective table structures of the database structure.

4. The system of claim 1, the system further to:
initiate, in parallel, a build of the database structure to generate the dimensional identifier, assign the dimensional identifier, and link the fact object.

5. The system of claim 1, the system further to:
initiate, in parallel, a build of the database structure to generate the dimensional identifier and link the fact object in parallel with the assigning.

6. The system of claim 1, wherein the dimensional identifier comprises a universally unique identifier (UUID) derived from one or more of the natural keys.

7. The system of claim 1, wherein the system associates the dimensional identifier with the fact object by embedding the dimensional identifier in the fact object.

8. The system of claim 7, where the system embeds the dimensional identifier in a field of the fact object corresponding to a reference to the dimensional object.

9. The system of claim 1, the system further to:
execute a query operation by referencing the dimensional identifier.

10. A method to generate a database structure with a low-latency key architecture, the method comprising:
identifying one or more natural keys of at least one dimensional object, the dimensional object corresponding to at least a portion of a database structure;
identifying at least one dependency of at least one fact object on the dimensional object, the fact object corresponding to the database structure;
generating, based on one or more of the natural keys, at least one dimensional identifier associated with the dimensional object;
assigning, to the dimensional object, the dimensional identifier to the dimensional object; and
linking, concurrently with the assigning, the fact object to the dimensional object by associating the dimensional identifier with the fact object, to generate the database structure.

11. The method of claim 10, further comprising:
generating the dimensional identifier by generating a hash of one or more of the natural keys.

12. The method of claim 10, wherein the dimensional object and the fact object correspond to respective table structures of the database structure.

13. The method of claim 10, further comprising:
initiating, in parallel, a build of the database structure to generate the dimensional identifier, assign the dimensional identifier, and link the fact object.

14. The method of claim 10, further comprising:
initiating, in parallel, a build of the database structure to generate the dimensional identifier and link the fact object in parallel with the assigning.

15. The method of claim 10, wherein the dimensional identifier comprises a universally unique identifier (UUID) derived from one or more of the natural keys.

16. The method of claim 10, wherein the associating the dimensional identifier with the fact object comprises:
embedding the dimensional identifier in the fact object.

17. The method of claim 7, wherein the embedding comprises:
embedding the dimensional identifier in a field of the fact object corresponding to a reference to the dimensional object.

18. The method of claim 10, further comprising:
execute a query operation by referencing the dimensional identifier.

19. A computer readable medium including one or more instructions stored thereon and executable by a processor to:
identify, by the first processor, one or more natural keys of at least one dimensional object, the dimensional object corresponding to at least a portion of a database structure;
identify, by the first processor, at least one dependency of at least one fact object on the dimensional object, the fact object corresponding to the database structure;
generate, by the first processor and based on one or more of the natural keys, at least one dimensional identifier associated with the dimensional object;
assign, by the first processor to the dimensional object, the dimensional identifier to the dimensional object; and
link, by at least one of the first processor and a second processor, concurrently with the assigning, the fact object to the dimensional object by associating the dimensional identifier with the fact object, to generate the database structure.

20. The computer readable medium of claim 19, wherein the computer readable medium further includes one or more instructions executable by the processor to:
initiate, by the second processor in parallel with the first processor, a build of the database structure to generate the dimensional identifier and link the fact object in parallel with the assigning.
